(19) United States
(12) Patent Application Publication
(10) Pub. No.: US 2009/0076893 A1
(43) Pub. Date: Mar. 19, 2009

(54) METHOD FOR MEMORIALIZING AN INDIVIDUAL'S CREATIVE WORKS

(76) Inventor: George A. Castineiras, Farmington, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/854,577

(22) Filed: Sep. 13, 2007

(51) Int. Cl. G06Q 30/00; G06F 17/30

(52) U.S. Cl. 705/14; 705/26

(57) ABSTRACT

A facilitating entity solicits or is solicited by an organization wishing to conduct a program on a regular basis whereby participants' creative works are memorialized via the creation of commemorative prints. The organization is provided with instructions regarding the conduct of the program. Creative works are received in at least one of electronic and non-electronic format. Creative works received, if any, in non-electronic format are converted to electronic format. The creative works in electronic format along with other information relevant to at least one of the participants, the organization and the program are stored in a content database, the content database being operable to associate the stored creative works with at least a portion of the other information. Orders are received and the commemorative works are generated for the creative works stored in the content database.

### FIELD OF THE INVENTION

The present invention is generally directed to the generation of creative works and is more particularly directed to a serial program for regularly memorializing an individual's perceptions as they relate to different periods of time and/or different subjects or themes.

### BACKGROUND OF THE INVENTION

People often enjoy looking back on their past or the past of a loved one such as a child to reflect on how they or their loved one progressed and developed. However, memory is often vague and the items a person has in their possession, if any, often are insufficient to refresh that memory. Even if a person has managed to collect and retain such things as a child's artwork or other creative works, often these collections are inconsistent and leave large periods of time unaccounted for. In addition, the items in any particular collection may not be indicative of how or what the child or other person was thinking at the time, but rather may simply be the result of a drawing or writing assignment in school. Accordingly, such items often provide an inaccurate picture of an individual's development and/or perspective.

Organizations such as schools will typically conduct an annual program whereby students in the school have their photographs taken. These photographs chronicle the changes in an individual's appearance over a period of time. However, such programs provide no information regarding an individual's perspective at a particular time in life, or with respect to a particular theme or subject. Nor do such programs provide insight regarding such perspective on a regular, serial basis.

### SUMMARY OF THE PRESENT INVENTION

The present invention resides in one aspect in a method for memorializing creative works whereby a facilitating entity solicits or is solicited by an organization wishing to conduct a program on a regular basis whereby participants' creative works are memorialized via the generation of commemorative prints bearing the creative works. These commemorative prints are indicative of the mental evolution of an individual. Once an organization decides to conduct the program, instructions are provided thereto regarding the program's conduct. Once generated, the creative works are received in either electronic or non-electronic format. Any creative works received in non-electronic format are converted by the facilitating entity or another entity acting on behalf of the facilitating entity, to electronic format and stored along with those provided in electronic format in a content database. In addition to the creative works, other information relevant to at least one of, the participants, participant perspective, events, program theme, and/or the organization, is also stored in the content database. The content database is operable to associate the stored creative works with at least a portion of the above-described other information. Orders are then received for the commemorative prints. At a point subsequent to receiving the orders, the commemorative prints are generated from the creative works stored in the content database. The commemorative prints are then distributed to at least one of the purchasers of the commemorative prints and the organization.

In an embodiment of the present invention, after conducting an initial program the facilitating entity conducts at least one additional program wherein at least a portion of the participants in the additional program also participated in the initial program. One such organization can be a school, generally having more than one grade level. An initial program, as described above, is conducted for the lowest grade level with the above-described additional program includes conducting such programs at least annually for successive grade levels.

Preferably, upon an individual leaving an organization, such as upon graduation, a collage of the individual's creative works/commemorative prints that were generated during at least a portion of the time during which the individual was associated with the organization, can be purchased either directly or indirectly from the facilitating entity. An indirect purchase would constitute, but is not limited to purchasing commemorative prints for the organization which in turn purchasers the commemorative prints from the facilitating entity. The collage can be created by or on behalf of the facilitating entity. In another embodiment of the present invention, the collage can be created by an entity other than the facilitating entity by accessing a website whereby the individual's creative works can be viewed and organized into the collage. In addition to, or in lieu of the collage, the individual's creative works can be organized into the form of a book. Portions of the book can be provided for persons to insert comments, photographs and the like. These comments, photographs, etc. can be inserted by the facilitating entity, or by the persons themselves either electronically via the above-described website or manually once the book is received. In addition, the present invention also contemplates an “events” section following one or more of the creative works in the book. In the events section, information concerning the individual, the artwork, and if applicable, program themes can be inserted, and/or information concerning local, national, and/or international events that took place at the time that a particular creative work was generated.

The above described book and/or collage can be stored in the content database so that for a period of time, one or all of the book, collage and commemorative prints can be purchased. In addition, the book, commemorative prints and/or collage may also be viewed on a website and/or webpage cooperable with the content database. In an embodiment of the present invention, the book can take the form of a calendar, A subscription fee can be charged for the maintenance of the website and/or web page. Advertising can also be included on the webpages with advertisements taking the form of a banner ad and/or a link to the advertiser's website. The entity to whom the advertisement and/or link pertains can pay a fee to the facilitating entity and/or offer discounts on products to those accessing the website.

### DETAILED DESCRIPTION OF THE PREFERRED EMBODIMENTS OF THE PRESENT INVENTION

The present invention is directed in one aspect to a method for capturing a child's or other person's mental and creative development with a systematic process of conducting programs on a regular basis (annually, semi-annually or more or less frequently) whereby creative works generated by the individual are converted into commemorative prints.

To conduct a program, an organization such as a school, non-profit entity, a church, club, or the like, contacts a company or other entity (hereinafter referred to as the facilitating entity) that will facilitate the conduct of the program. The facilitating entity may distribute forms upon which the participant's creative works are positioned. The phrase “creative works” should be broadly construed herein to include, but not be limited to, drawings, paintings, poems, stories, essays, collages, custom postage and the like. In addition, “positioning the creative works on the forms” should be broadly construed to include drawing and/or painting directly onto the form, writing directly on the form, gluing, taping, or otherwise fastening items, drawings, paintings, and or writings onto the form. While the use of forms upon which to create or otherwise affix the above-described creative works onto have been described herein, the present invention is not limited in this regard as the creative works can be produced on paper, or electronically on a computer without departing from the broader aspects of the present invention.

In order to conduct the above-described program, the facilitating entity can also solicit the organization desiring to conduct the program. This solicitation can take the form of phone calls, faxes, e-mails, regular mail, combinations thereof, and the like. The facilitating entity can also employ a website through which information about the program can be one or more of observed, downloaded, and/or requested. In addition, the website may provide means therein by which the facilitating entity can be contacted. The website may also have advertising thereon. The advertising can take the form of banner-type ads on the website or these advertisements can be in the form of links to an advertiser's website. The facilitating entity can charge a fee to the advertisers for allowing the advertisements on the above-described website. While the facilitating entity has been described as contacting the organization, the present invention is not limited in this regard as the organization can also initially contact the facilitating entity.

Once an organization or other entity decides to conduct a program, the facilitating entity can provide the organization with forms as well as with instructions for conducting the program. In lieu of providing the organization with instructions and/or forms, these items may be made available to the organization via download from the internet. This download can be accomplished via the above-described website or some other site. The organization may accomplish downloading the forms and/or instructions, or participants in the program may be given instructions regarding how to download the forms themselves.

Once the participants are in possession of the forms, they then can position their creative works thereon. Once this is accomplished, the forms can be returned to the organization for which the program is being conducted, and the organization can forward the completed forms to the facilitating entity or an entity acting on behalf of the facilitating entity. While forms have been described as being provided in hard-copy or downloadable format, the present invention is not limited in this regard. The program described herein can be conducted without the use of forms. The creative works can also be generated on media, such as paper, cardboard, plastic and the like. The creative works can also be generated electronically and forwarded electronically to the facilitating entity. Once received by the facilitating entity, or other entity acting on behalf thereof, the creative works that are not in an electronic form are scanned into a database. The database and software associated therewith allow for the entry of information regarding the organization and participants for which the program is being conducted and also allows for each creative work to be matched to the appropriate participant and organization for tracking purposes. In lieu of forms, the facilitating entity may provide the organization and/or participants in the program with information regarding acceptable sizes and content regarding the creative works.

In an embodiment of the present invention, the creative works are posted on a web site accessible by the participants or others wishing to purchase copies of one or more creative works. The web site may contain password protection or other security protocols that would limit access to images relevant to a particular user and/or to a particular organization.

In another embodiment, the participant can customize the commemorative print by selecting a border or other embellishment such as text or clipart and the like to be placed on the creative work. This selection may be accomplished by picking the embellishment from printed images. Similarly, the participant may also be able to access his/her creative work via the above-described website and choose the embellishment from a listing of the embellishments on the website. The participant, via programming associated with the website, may also be able to view his/her creative work having the embellishments thereon, on the website.

During the conduct of the program and preferably for a period of time thereafter, orders for the commemorative prints will be taken. Orders can be solicited by the organization, other individuals and/or the participants in the program. These orders may be accomplished, with or without an order form. Orders can be submitted to the facilitating entity or another entity, if so designated, acting on behalf of the facilitating entity. Order submission can be accomplished by submitting order information by phone, fax, mail, e-mail, and the like. In addition, in an embodiment of the present invention, the orders may be taken online via the above-described website or another site. When taken online, order information can be automatically saved in the content database and associated with the participant, and/or the particular organization. In order to facilitate ordering, information identifying a particular creative work can be submitted to the appropriate entity with the order. This information can take the form of indicia identifying the participant, such as the participant's name, the organization's name, a barcode, and the like.

When, or soon after, an item(s) is ordered, payment for the item(s) needs to be made. Payment can be made in any conventional manner, such as by cash, check, credit card, money order, and the like. Payment may also be made over the internet or by using a web-based payment site such as, but not limited to PayPal®. Once orders are received, the commemorative prints can be created. The commemorative prints can be printed by the facilitating company or an entity acting on behalf of the facilitating entity. Once generated, the commemorative prints can be distributed to the purchasers. Distribution can be accomplished by forwarding all of the ordered commemorative prints to the organization, forwarding the commemorative prints to the participants, forwarding the commemorative prints to the purchasers, or combinations thereof. In addition, the present invention contemplates using printers located at various locations or loaned, rented or sold to the organization, whereby printing materials can be supplied to the organization and subsequent to the supply by or on behalf of the facilitating entity, the commemorative prints can be generated on site.

In addition to the commemorative prints, other items bearing the creative work can also be provided. These items include such things as, but are not limited to, plaques, note cards, postcards, mugs, plates, key chains, wrapping paper, gift bags, and the like.

The above-described programs can also be thematic, with the creative works being directed to particular subject matter. For example, the themes can be, but are not limited to self-portraits, family, vacation, dreams, “what I want to be when I grow up”, favorite sports, holidays, favorite songs, favorite color, books, and the like. The themes can also be directed to an individual's beliefs. The creative works can be directed toward gaining insight into a participant's perspective at the particular time in the participant's life when the program is conducted.

In one embodiment the above-described themes can be directed to the answers to one or more questions, such as, but not limited to:
If I had a million dollars I would ______?
I want my car to look like ______?
I'm happiest when ______?
If I were President I would ______?

In another aspect of the present invention, a collection of previously created creative works commemorative prints are made available to combine into a collage. The images from past programs can be posted on the above-described or another website where a user can arrange them into a collage. The user can be given the option of choosing to only include some of the creative works unique to a particular individual in the collage, or all of the individual's creative works. Alternatively, a person or entity desiring to purchase a collage may choose a number of creative works of an individual and the facilitating company creates the collage. In still another embodiment of the present invention, a purchaser can choose the creative works of several different individual's to create the collage. This can occur, for example, when a purchaser has more than one child participating in the program, or where it is desired to have a group of different children's creative works made into a collage, such as, for example, when all of the children are in the same class together. The collages can also be specific to particular classes, such as, but not limited to, language arts or geography. Upon a child's or individual's graduation or exit from an organization, school, or other institution, the facilitating entity may on its own or upon a request from the organization create a collage of the creative works stored in the database for the particular individual.

In another embodiment of the present invention, the creative works can be collected and compiled into book form. Portions of the book can be provided for persons to insert comments, photographs and the like. These comments, photographs, etc. can be inserted by the facilitating entity, or by the persons themselves either electronically via the above-described website or manually once the book is received. In addition, the present invention also contemplates an “events” area following one or more of the creative works in the book. In the events area, information can be inserted concerning the individual, and/or information concerning the program, an individual's perspective, local, national, and/or international events that took place at the time that a particular creative work was generated. Instead of a book, the creative works can be compiled into the form of a calendar.

The above described book, calendar, and/or collage can be stored in the content database so that for a period of time, one or all of the book, calendar, collage and commemorative prints can be purchased. In addition, they may also be viewed on a website and/or webpage cooperable with the content database. A subscription fee can be charged for the maintenance of the website and/or web page. A yearbook is also contemplated by the present invention. The yearbook can include the entire body of creative works generated by an organization or a portion thereof. For example, where the organization is a school, the yearbook could be a compilation of creative works for the whole school, a single grade, or a single classroom. In addition, the yearbook can also span several programs over a period of years. The creative works can also be subject to judging with certain chosen works being highlighted in the book.

In another embodiment of the present invention, a participant can be given a web-page unique to him/her upon which the participant's creative work can be displayed along with, but not limited to biographical or other information relevant to the participant, as well as a photograph of the participant. The participant may also be given the ability to post other information and/or creative works on the webpage. This additional information would be subject to the approval of the facilitating company. In addition, the entry to the above-described web page can require entry of a password or other security protocol. While a photograph of the participant has been described, it is not requisite that it appear on the website. The website can also include advertising thereon. The advertising can take the form of banner ads, and/or links to other websites. The website may also identify via information, advertisements and/or links for charities chosen by the individual, the facilitating entity or both. The facilitating entity may collect donations for or on behalf of the charity or via a link on the website, the charity can be accessed directly.

In still another embodiment, the above-described program could be run in conjunction with an annual photograph program such as is done in schools. A participants photograph along with the above-described creative work could be supplied together and/or be included on the same media. For example, the creative work and photograph could be presented side-by-side on the same media. Alternatively, the creative work could be presented on one side of the media and the photograph on the other.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A method for memorializing creative works comprising:
a. one of a facilitating entity soliciting or being solicited by an organization wishing to conduct a program on a regular basis whereby participants' creative works are memorialized via the creation of commemorative prints;
b. providing said organization with instructions regarding the conduct of said program;
c. receiving said creative works in at least one of electronic and non-electronic format;
d. converting creative works received, if any, in non-electronic format, to electronic format;
e. storing said creative works in electronic format, and other information relevant to at least one of said participants, said organization and said program, in a content database, said content database being operable to associate said stored creative works with at least a portion of said other information;
f. receiving orders for said commemorative prints;
g. generating said commemorative prints from said creative works stored in said content database; and
h. distributing said commemorative prints to at least one of said participants, purchasers of said commemorative prints and said organization.

2. A method as defined by claim 1 wherein after conducting an initial program said method comprises the further step of said facilitating entity conducting at least one additional program as defined by steps b-h at a time subsequent to said initial program, and wherein at least a portion of said participants in said additional program also participated in said initial program.

3. A method as defined by claim 2 wherein said organization is a school having more than one grade level, said initial program being conducted at least one of said grade levels; and wherein said step of conducting at least one additional program includes conducting said additional program, at least for the next successive grade level.

4. A method as defined by claim 1 further comprising the steps of:
offering a collage of a creative works for purchase, said collage including at least two of said participant's creative works corresponding to said participant's participation in at least two of said programs.

5. A method as defined by claim 1 further comprising the steps of, one of said facilitating entity or another entity acting on behalf of said facilitating entity providing forms onto which said participants can locate said creative works.

6. A method as defined by claim 1 further comprising the step of storing an image of said commemorative print in said content database.

7. A method as defined by claim 1 comprising the further steps of providing a web site upon which images of said commemorative prints can be viewed.

8. A method as defined by claim 6 wherein said step of providing said website further includes:
providing access to web pages within said website, said webpages displaying at least one of said participant's creative works and said creative works specific to a particular organization.

9. A method as defined by claim 8 further comprising the step of requiring security protocols to be entered into an area of said website so that a user thereof can access said web pages.

10. A method as defined by claim 9 further comprising the step of providing said security protocols to at least one of said participant and said organization.

11. A method as defined by claim 1 further comprising the steps of providing at least one website upon which an individual can view images of said commemorative prints created by said individual.

12. A method as defined by claim 11 wherein said at least one website includes web pages unique to and accessible by at least one of said organization and said individual.

13. A method as defined by claim 12 comprising the further steps of providing means for entering security protocols that allow access to said web pages.

14. A method as defined by claim 1 comprising the further step of said facilitating entity producing a publication comprising a compilation of said creative works of at least a portion of said participants.

15. A method as defined by claim 14 wherein said publication is produced subsequent to a program.

16. A method as defined by claim 1 comprising the further steps of:
compiling an individual's creative works into a book form; and
offering said book for sale.

17. A method as defined by claim 16 comprising the further steps of:
providing at least one events area in said book.

18. A method as defined by claim 17 comprising the further step of:
populating at least a portion of said area events area with historical information relevant to the period of time at which a particular creative work was generated.

19. A method as defined by claim 1 comprising the further steps of:
compiling an individual's creative works into a collage form.

20. A method as defined by claim 11 comprising the further steps of:
Providing advertising on said website.

21. A method as defined by claim 20 wherein said advertising in the form of at least one of a banner advertisement and a link to an advertiser's website.

22. A method as defined by claim 1 wherein said method comprises the further steps of:
obtaining a photograph of at least one of said participants, and storing said photograph in said content database, said content database being operable to associate said photograph with at least a portion of said other information; and
said step of receiving orders includes receiving orders for a commemorative presentation that includes said photograph and said commemorative print presented together.

23. A method as defined by claim 1 comprising the further step of providing means for customizing said commemorative print.
